(19) United States
(12) Patent Application Publication
(10) Pub. No.: US 2026/0080037 A1
(43) Pub. Date: Mar. 19, 2026

(54) UNBIASED WATERMARK FOR LARGE LANGUAGE MODELS

(71) Applicant: UNIVERSITY OF MARYLAND, COLLEGE PARK, College Park, MD (US)

(72) Inventors: Zhengmian HU, College park, MD (US); Heng HUANG, Potomac, MD (US)

(21) Appl. No.: 19/329,343

(22) Filed: Sep. 15, 2025

Related U.S. Application Data
(60) Provisional application No. 63/694,907, filed on Sep. 15, 2024.

(51) Int. Cl. G06F 21/16

(52) U.S. Cl. CPC G06F 21/16

(57) ABSTRACT

Systems, methods, apparatuses, and computer program products for providing and detecting watermarking in large language models (LLM). A method for watermarking a LLM may include inputting, into the LLM, a sequence of tokens conditioned on a given context to obtain an output distribution. The method may also include extracting a context code from the sequence of tokens. The method may further include generating a watermark code by combining the context code with a private key held by a service provider. In addition, the method may include adjusting, based on the watermark code, a probability of the tokens in the sequence of tokens. Further, the method may include sampling a watermarked output from a distribution of the sequence of tokens based on the adjustment and the context code.

### CROSS-REFERENCE TO RELATED APPLICATION

This application claims priority from U.S. provisional patent application No. 63/694,907 filed on Sep. 15, 2024. The contents of this earlier filed application are hereby incorporated by reference in their entirety.

### FIELD

Some embodiments may generally relate to watermarking. For example, certain example embodiments may relate to apparatuses, systems, and/or methods for providing and detecting watermarking in large language models (LLM).

### BACKGROUND

Large language models (LLMs) have advanced to the point where they can generate text that is nearly indistinguishable from human writing, which poses significant challenges in preventing the dissemination of malicious content and controlling the spread of synthetic data. This raises concerns about misuse for activities such as, for example, disinformation campaigns, spam, or fraudulent communications.

One approach to mitigate the risks in LLMs is to incorporate watermarking techniques into LLMs, allowing for the tracking and attribution of model outputs. Existing detection methods often rely on statistical analysis or require access to the model's internal parameters, which is not always feasible or reliable, especially when models are proprietary or when adversaries employ strategies such as paraphrasing to evade detection. Additionally, some approaches can degrade the quality of the generated text or impose constraints that limit the utility of the models. Thus, there is a need for techniques that can embed imperceptible signals into generated text (e.g., machine generated content), enabling effective detection without compromising text quality or requiring access to the underlying model.

### SUMMARY

Some embodiments may be directed to a method of watermarking a large language model (LLM). The method may include inputting, into the LLM, a sequence of tokens conditioned on a given context to obtain an output distribution. The method may also include extracting a context code from the sequence of tokens. The method may further include generating a watermark code by combining the context code with a private key held by a service provider. In addition, the method may include adjusting, based on the watermark code, a probability of the tokens in the sequence of tokens. Further, the method may include sampling a watermarked output from a distribution of the sequence of tokens based on the adjustment and the context code.

Other embodiments may be directed to an apparatus. The apparatus may include at least one processor and at least one memory including computer program code. The at least one memory and computer program code may be configured to, with the at least one processor, cause the apparatus at least to input, into the LLM, a sequence of tokens conditioned on a given context to obtain an output distribution. The apparatus may also be caused to extract a context code from the sequence of tokens. The apparatus may further be caused to generate a watermark code by combining the context code with a private key held by a service provider. In addition, the apparatus may be caused to adjust, based on the watermark code, a probability of the tokens in the sequence of tokens. Further, the apparatus may be caused to sample a watermarked output from a distribution of the sequence of tokens based on the adjustment and the context code.

Other embodiments may be directed to an apparatus. The apparatus may include means for inputting, into the LLM, a sequence of tokens conditioned on a given context to obtain an output distribution. The apparatus may also include means for extracting a context code from the sequence of tokens. The apparatus may further include means for generating a watermark code by combining the context code with a private key held by a service provider. In addition, the apparatus may include means for adjusting, based on the watermark code, a probability of the tokens in the sequence of tokens. Further, the apparatus may include means for sampling a watermarked output from a distribution of the sequence of tokens based on the adjustment and the context code.

In accordance with other embodiments, a non-transitory computer readable medium may be encoded with instructions that may, when executed in hardware, perform a method. The method may include inputting, into the LLM, a sequence of tokens conditioned on a given context to obtain an output distribution. The method may also include extracting a context code from the sequence of tokens. The method may further include generating a watermark code by combining the context code with a private key held by a service provider. In addition, the method may include adjusting, based on the watermark code, a probability of the tokens in the sequence of tokens. Further, the method may include sampling a watermarked output from a distribution of the sequence of tokens based on the adjustment and the context code.

Other embodiments may be directed to a computer program product that performs a method. The method may include inputting, into the LLM, a sequence of tokens conditioned on a given context to obtain an output distribution. The method may also include extracting a context code from the sequence of tokens. The method may further include generating a watermark code by combining the context code with a private key held by a service provider. In addition, the method may include adjusting, based on the watermark code, a probability of the tokens in the sequence of tokens. Further, the method may include sampling a watermarked output from a distribution of the sequence of tokens based on the adjustment and the context code.

Other embodiments may be directed to a method of detecting watermarking in an output of a LLM. The method may include implementing a score-based testing of the sequence of tokens by assigning a score to each token in the sequence. The method may also include determining, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

Other embodiments may be directed to an apparatus. The apparatus may include at least one processor and at least one memory including computer program code. The at least one memory and computer program code may be configured to, with the at least one processor, cause the apparatus at least to implement a score-based testing of the sequence of tokens by assigning a score to each token in the sequence. The apparatus may also be caused to, with the at least one processor, determine, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

Other embodiments may be directed to an apparatus. The apparatus may include means for implementing a score-based testing of the sequence of tokens by assigning a score to each token in the sequence. The apparatus may also include means for determining, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

In accordance with other embodiments, a non-transitory computer readable medium may be encoded with instructions that may, when executed in hardware, perform a method. The method may include implementing a score-based testing of the sequence of tokens by assigning a score to each token in the sequence. The method may also include determining, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

Other embodiments may be directed to a computer program product that performs a method. The method may include implementing a score-based testing of the sequence of tokens by assigning a score to each token in the sequence. The method may also include determining, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

### BRIEF DESCRIPTION OF THE DRAWINGS

For proper understanding of example embodiments, reference should be made to the accompanying drawings, wherein:

FIG. 1 illustrates an example of unbiased reweighting, according to certain embodiments.

FIG. 2 illustrates an example of another unbiased reweighting, according to certain embodiments.

FIG. 3 illustrates an example watermarking flow, according to certain embodiments.

FIG. 4 illustrates an example watermarking framework, according to certain embodiments.

FIG. 5A illustrates an example distribution of perplexity of outputs for text summarization (TS) and bilingual evaluation understudy (BLEU) score for machine translation (MT), according to certain embodiments.

FIG. 5B illustrates an example of another distribution of perplexity of outputs for TS and BLEU score for machine translation (MT), according to certain embodiments.

FIG. 6 illustrates a table of performance results of different watermarking methods, according to certain embodiments.

FIG. 7 illustrates a table of a mean and variance score per token for different reweighting methods and different tasks, according to certain embodiments.

FIG. 8 illustrates an example flow diagram of a method, according to certain embodiments.

FIG. 9 illustrates an example flow diagram of another method, according to certain embodiments.

FIG. 10 illustrates an apparatus, according to certain embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for providing and detecting watermarking in large language models (LLM).

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain embodiments, and not in limitation thereof.

LLMs may write documents, create executable code, and answer questions, often with human-like capabilities. As these systems become more pervasive, there is an increasing risk that they may be used for malicious purposes. Examples of malicious purposes may include social engineering and election manipulation campaigns that exploit automated bots on social media platforms, creation of fake news and web content, and use of artificial intelligence (AI) systems for cheating on academic writing and coding assignments. Furthermore, the proliferation of synthetic data on the web can complicate future dataset creation efforts, as synthetic data may often be inferior to human content and must be detected and excluded before model training. Thus, the ability to detect and audit the usage of machine generated text may be important to reduce harm for LLMs.

Potential harms stemming from LLMs may be mitigated by watermarking the model output. For example, watermarking signals may be embedded into generated text (e.g., machine generated text) that are invisible to humans but algorithmically detectable from a short span of tokens. Thus, certain embodiments described herein may provide watermarking and watermarking detection in LLMs. The watermark may be embedded with negligible impact on text quality, and can be detected using an efficient open-source algorithm without access to the LM application programming interface (API) or parameters.

According to certain embodiments, providing watermarking as an unbiased watermark may make it nearly impossible for users to discern whether a service provider (e.g., organization or platform providing the LLM and/or related services) has incorporated watermarks or not. Furthermore, the presence of watermarks does not compromise the performance of the model in downstream tasks, ensuring that the overall utility of the language model is preserved. Certain embodiments therefore contribute to the ongoing interest around responsible AI development, suggesting that unbiased watermarks may serve as an effective means of tracking and attributing model outputs without sacrificing output quality.

Watermarking techniques can serve multiple purposes, such as embedding ownership information within the generated text to protect the intellectual property rights of the model. It can also help mitigate potential harm caused by LLMs by monitoring where the model is being used and whether it is being misused or abused.

A good watermarking method should not adversely affect the normal usage of the language model or degrade the quality of the generated text. However, sometimes there may be some trade-off between the strength of the watermark and the quality of the output text. For instance, in a method that augments the logits of a randomly selected set of “green” tokens (e.g., preferred or promoted tokens), by tuning the “magnitude of logits adjustment”, there may be a trade-off between watermark strength and text quality. The “green” tokens may be computed by randomly splitting the full vocabulary into “green” (promoted) and “red” (suppressed) lists. The split is deterministic but context-dependent, controlled by a random seed derived from the input context and a secret watermark key.

Certain embodiments show that with the right implementation, watermarking can be accomplished without affecting the output quality. This particular type of watermark may be referred to as an unbiased watermark. In certain embodiments, if the watermark causes a decline in output quality, there may be a method to detect the presence of the watermark based on the quality. Conversely, if the watermark cannot be detected, it implies that the output quality remains unaffected. A watermark is undetectable if one (without the watermark key) cannot distinguish between outputs from two services: one applying the watermark, and one that does not apply the watermark. Specifically, given a black-box access to one randomly selected service (watermarked or non-watermarked), and no knowledge of the watermark key, one would not be able to determine whether the watermark is present.

According to certain embodiments, an undetectable watermark may be unbiased. For instance, if a watermark is biased, the degradation in text quality or the systematic preference for certain tokens would be observable, making the watermark detectable. However, if a watermark is unbiased, it preserves the original LLM's output distribution. Further, any detection function ‘is watermarked=f(x)’ may have an identical average for watermarked and non-watermarked text. One would not be able to statistically differentiate between watermarked and non-watermarked text.

Certain embodiments may provide a proof that with a suitable implementation, watermarking does not affect the output probability distribution. This has significant implications, as users who do not have the private key are unable to discern whether a service provider has applied watermarking to the model. Furthermore, the addition of watermarking does not affect the performance of the generated text in any downstream tasks.

As described herein, certain embodiments introduce an unbiased watermark, a family of watermark methods that guarantee the non-degradation of text quality. Certain embodiments may also provide a comprehensive framework that facilitates the design and detection of unbiased watermarks. Additionally, certain embodiments provide various reweight techniques that demonstrate the ability to preserve output quality in machine translation and text summarization tasks. Certain embodiments may also provide a max/min variant of a log-likelihood ratio (LLR) to test for watermark detection. This detection method may come with theoretical guarantees, specifically an upper bound on type I error and, thus, enhancing the reliability of watermark detection in language models (LMs).

In the context of LLMs, Σ denotes a vocabulary set of text, which is a set of all possible units of text (e.g., whole words, parts of a word, or a character or punctuation mark) known as tokens that an LLM can generate in a single step. The set Σ* may be defined as a collection of all possible strings of any length including those of length zero.

An LLM may generate a sequence of tokens conditions on a given context (e.g., or prefix, refers to the complete, evolving input available to the model at a specific generation step). In a single step, the probability of generating the next token xₙ₊₁⊂Σ given the current context, x₁,x₂, . . . ,xₙ, can be denoted as P_{M}(xₙ₊₁| x₁,x₂, . . . ,xₙ). The LLM may operate in an autoregressive fashion where the joint probability of generating multiple tokens xₙ₊₁, . . . ,xₙ₊ₘ may be written as:

$${P}_{M} ( {x}_{n + 1} , … , {x}_{n + m} \vert {x}_{1} , {x}_{2} , … , {x}_{n} ) = {\prod }_{i = 1}^{m} {P}_{M} ( {x}_{n + i} \vert {x}_{1} , {x}_{2} , … , {x}_{n} , {x}_{n + 1} , … , {x}_{n + i - 1} ) .$$

For simplicity, the following notation may be used: P_{M}(x_{n+1:n+m}|x_{1:n}), where x_{n+1:n+m}=(xₙ₊₁, . . . ,xₙ₊ₘ)∈Σ*.

According to certain embodiments, an autoregressive model may generate text one token at a time. Starting from a prompt (e.g., initial, fixed input provided by the user to start generation), the autoregressive model may predict the next token, append that token to the prompt, and repeat the prediction on the extended prompt. For example, to produce the sentence “I like to eat apple for breakfast”, with the prompt “I like to eat”, the model may proceed in the following manner: (1) Predict “apple” from the prompt “I like to eat”; (2) Append “apple” to the new prompt “I like to eat apple”; (3) Predict “for” from the new prompt; (4) Append “for” to the new prompt “I like to eat apple for”; and (5) Predict “breakfast” from the new prompt. From this example, the final output is the concatenation of all generated tokens.

In certain embodiments, scoring of the tokens may be performed in an autoregressive manner. For example, when a detection score is computed autoregressively, the score for the full sentence may be obtained by summing the individual scores for each generated token conditioned on its own prefix. Using the above example, a score may first be determined for “apple” given the prefix “I like to eat”. Next, the score for “for” may be determined given the prefix “I like to eat”. Finally, the score for “breakfast” may be determined given the prefix “I like to eat apple for”. Thus, the final detection score for “I like to eat apple for breakfast” is the sum of the three token-level scores.

In the context of watermarking, a given private key k from a key space K. The key k E K may be selected at random from a prior distribution P_{K}(k). The watermarked output of the LLM may follow the distribution P_{M,w}(xₙ₊₁| x₁,x₂, . . . ,xₙ;k), which is conditioned on both the key k and the context x_{1:n}. Similarly, the notation P_{M,w}(x_{n+1:n+m}| x_{1:n}; k) may be used for the probability of generating a sequence of tokens in a watermarked model.

According to certain example embodiments, a watermarking scheme may be efficiently detectable by a holder of the private key k, and the watermarking scheme cannot be detected by users while at the same time, does not negatively impact the quality of the output.

In certain embodiments, it may be possible to detect watermarks by users because it is closely related to the output quality. For example, if the watermark causes a degradation in the output quality, there may be a method to infer the presence of the watermark by examining the quality of the output. Conversely, if the watermark is undetectable, it may imply that the watermark does not impact the output quality.

A watermark may be considered undetectable if the probability distributions of the watermarked and non-watermarked outputs are identical. For example, probability distribution may refer to the complete set of likelihoods assigned to every possible output sequence (e.g., sentences) that a language model can generate for a given prompt. To capture this notion, several properties of watermarking schemes may be defined. For example, one watermarking scheme may include n-shot-undetectable scheme. In this scheme, for a fixed input sequence a∈Σ*, the watermarked LLM and the key prior pair (P_{M,w},P_{K}) is n-shot-undetectable compared to the original LLM P_{M} if:

$$\begin{matrix}{\prod }_{i = 1}^{n} {P}_{M} ( {x}^{i} \vert a ) = {\sum }_{k ∈ K} {P}_{K} ( k ) {\prod }_{i = 1}^{n} {P}_{M , w} ( {x}^{i} \vert a ; k ) , \\ for any n number of strings {x}^{i} ∈ {Σ}^{*} .\end{matrix}$$

Another watermarking scheme may include a downstream-invariant where the watermarked LLM and key prior pair (P_{M,w},P_{K}) are invariant compared to the original LLM P_{M} on downstream tasks if:

$${𝔼}_{x ∼ = {P}_{M , w} ( \cdot \vert a ; k ) , k ∼ {P}_{K}} [ f ( x ) ] = {𝔼}_{x ∼ {P}_{M} ( \cdot \vert a )} [ f ( x ) ] ,$$

for any strings x, a∈Σ*, and for any metric f:Σ*→ [symbol] .

According to certain embodiments, the one-shot-undetectable property implies the downstream invariant property, as identical distributions yield identical expectations for any function. This implication does not require the n-shot-undetectable property for n>1, which means a watermarking scheme that is one-shot-undetectable may still maintain the output quality for downstream tasks even if the user might discern the existence of the watermark through multiple generation requests.

In certain embodiments, the feasibility of undetectability of watermarking may be analyzed. As one example, a service provider that offers a random number in the set {0, 1}. A clean generation process may be represented as P_{M}(x)=1/2, ∀x∈{0,1}. It may be assumed that the key k belongs to the set {0, 1} and is selected with equal probability. With the watermark added, the probability of the new output may be expressed as: P_{M,w}(x|k)=δk(x).

According to certain embodiments, the one-shot-undetectable property may be represented as P_{M}(x)=Σ_{K∈K}P_{M,w}(x|k)P_{K}(k). Assuming that a user can only make a single request to the service, if the user is unaware of the key, the user will be unable to distinguish whether the received result is watermarked or not. Thus, in this scenario, the undetectability of the watermark is achieved.

Although it may be possible to achieve undetectability of the watermark, there is a gap between this example and the practical implementation of watermarking in LLMs. For example, the symbol set Σ in LLMs is far more complex than the binary set {0, 1}, and the probability distribution is not uniform. Additionally, the generation process in LLMs is autoregressive, which means that more than one symbol are generated iteratively. Furthermore, the above example does not satisfy the n-shot-undetectable property for n>1. In certain embodiments, the underlying principles of undetectability may remain constant, while their application may become more intricate in a more complex environment.

According to certain embodiments, watermarking may be applied with unbiased reweighting. For instance, a random watermark code E and a reweight function R_{E}: Δ_{Σ}→Δ_{Σ} may depend on the random watermark code E. The set of all possible probability distributions on the symbol set Σ is denoted as Δ_{Σ}, which forms a simplex. The reweighting function may be a tuple (ε,P_{E},R) where ε is the watermark code space, P_{E} is a probability distribution on space ε, and R is a function R:ε×Δ_{Σ}→Δ_{Σ}. For a specific watermark code E∈ε, the partially evaluated reweighting function may be denoted as R_{E}:Δ_{Σ}−Δ_{Σ}.

In certain embodiments, given a random watermark code E, a reweighting function R_{E}:Δ_{Σ}→Δ_{Σ}, R is an unbiased reweighting function if and only if for all P∈Δ_{Σ}, [symbol] [R_{E}(P)]=P.

According to certain embodiments, several unbiased reweighting methods may be provided. For instance, in one example, the reweighting methods may include a δ-reweight where the watermark code space ε is the interval [0, 1], and P_{E} is the uniform probability on ε. Leveraging inverse transform sampling (generating a uniform [0,1] random variate ∪;RETURN←F⁻¹(U)) (see Devroye, Luc; “Non-Uniform Random Variate Generation”; Springer New York, 1986; the teachings of which are hereby incorporated by reference), it may be possible to sample from distribution P∈Δ_{Σ} using a uniformly distributed random number [0, 1]. Thus, it may be possible to obtain a mapping sampling: ε→Σ. The δ-reweight returns a delta distribution R_{E}(P)=δ_{sampling}_{_{P}}_{(E)}. According to some embodiments, while the reweighted distribution for each individual random event E is a delta distribution, the mean output token probabilities remain the original distribution P when considering the randomness of E.

The reweighting methods may also include a γ-reweight where ethe watermark code ε is the set of all bijective function between vocabularies in set Σ and a set of indices [|Σ|]={1, . . . ,|Σ|}, where |Σ| is the size of vocabularies set Σ. Any watermark code E is an indexing function for vocabularies set Σ, and is also equivalent to a total order on Σ. In the γ-reweight function, P_{E} may be set as the uniform probability on ε, making it easy to sample a watermark code/by randomly shuffling the symbol list.

According to certain embodiments, it may be assumed that the original distribution is P_{T}(t)∈Δ_{Σ}, ∀t∈Σ. Given the watermark code E:Σ→[|Σ|], auxiliary functions F_{I}(i)=Σ_{t∈Σ}1(E(t)≤i)P_{T}(t), and F_{S}(s)=max (2s−1,0), F_{I′}(i)=F_{S}(F_{I})(i)) may be constructed. The γ-reweight yields a new distribution P_{T′}(t)=F_{I′}(E(t))−F_{I′}(E(t)−1).

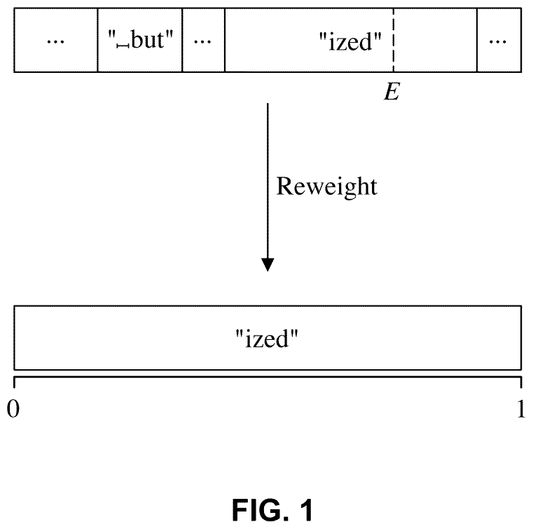

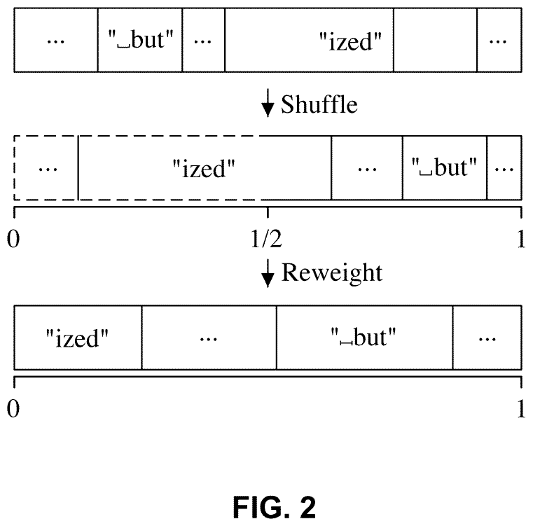

FIG. 1 illustrates an example δ-reweight method, according to certain embodiments, and FIG. 2 illustrates an example γ-reweight method, according to certain embodiments. As illustrated in FIGS. 1 and 2, each block represents a token, and the width of each block represents the probability of that token, which makes the total length 1. FIG. 1 illustrates the δ-reweight method where each individual random watermark code E∈[0,1] uniformly sampled from an interval of [0, 1] corresponds to a specific token according to the horizontal axis, and the reweighted distribution is just a δ distribution on that token such that the selected token has 1 probability, and all other vocabulary tokens have a probability of 0. FIG. 2 illustrates the γ-reweight method where ethe symbol set is shuffled, and then the left half of the regions are rejected. FIG. 2 also illustrates that the remaining regions are amplified with a factor of 2 (e.g., the token's generation probability may be altered—it may increase by as much as a factor of 2). In some embodiments, if the very first token in the reordered/shuffled symbol list carries more than ½ of the probability, no tokens are rejected, and the probably of that first token may be adjusted.

As illustrated in FIGS. 1 and 2, both methods are unbiased when considering the randomness of the watermark code E. For δ-reweight, since the probability of returning a δ distribution on a token is just the original probability on that token, the weighted average of all delta distributions is still the original probability. In the case of the γ-reweight, although certain regions are rejected and the other regions are amplified, every token has the same probability to be in the rejected or amplified region, thus ensuring the unbiased property.

In certain embodiments, reweighting may be provided for an autoregressive model. For instance, the reweighting methods may be applied to a single token-generation directly. Given a prefix x_{1:n}, the probability distribution for generating a new token without a watermark is denoted as P_{M}(·|x_{1:n})∈Δ_{Σ}. For a random watermark code E, a sample may be obtained from a new distribution P_{M,w}(·|x_{1:n})=R_{E}(P_{M}(·|x_{1:n})∈Δ_{Σ}. If the reweighting function is unbiased, the following may be obtained, [symbol] [R_{E}(P_{M}(·|x_{1:n}))]=P_{M}(·|x_{1:n}). This ensures that for an individual unaware of the watermark code, it is impossible to determine whether a new token is sampled directly from P_{M}(·|x_{1:n}) or from P_{M,w}(·|x_{1:n}; E) for a random watermark E. However, if the watermark code is known, one can perform statistical hypothesis testing to determine the likelihood of a token being sampled from either distribution. Since the LLM generation task is autoregressive, multiple reweighting steps may be required, with each step needing a watermark code Eᵢ for reweighting the distribution of token xᵢ.

In certain embodiments, Eᵢ values may be independent to ensure the unbiased nature of the entire sequence, rather than just the single-token generation process. Given an unbiased reweighting function (ε,P_{E},R), if Eᵢ values are independent and identically distributed (i.d.d.) with the distribution P_{E}, the following is obtained: [symbol] , . . . ,Eₙ [P_{M,w}(x_{1:n}|a_{1:m})]=P_{M}(x_{1:n}|a_{1:m}). If the Et values are not independent, it may not be possible to guarantee that the generation probability of the entire sequence remains unbiased. For example, in a case where all Eᵢ values are identical, it may be assumed that the correct distribution is a sequence where each token is a random 0 or 1 with equal probability. Identical Eᵢ values would result in identical token outputs, ultimately producing sequences consisting solely of 0's or 1's, which is biased.

According to certain embodiments, a large number of independent watermark codes Eᵢ may be constructed during watermarking, and the watermark codes Eᵢ may be used during watermark detection by combining information from the prefix and a secret key to construct Eᵢ.

For a single token generation process, given a prefix x₁,x₂, . . . ,xₙ, an abstract context code space C and an abstract context code generation function cc: Σ*→C may be considered. Based on the prefix, the context code cₙ₊₁=cc(x₁,x₂, . . . ,xₙ) may be constructed. Examples may include using the entire prefix cₙ₊₁=(x₁,x₂, . . . ,xₙ), and using the m most recent prefixes cₙ₊₁=(xₙ₋ₘ₊₁, . . . ,xₙ). The framework of certain embodiments may accommodate diverse context code generation approaches, particularly those that integrate error-correcting mechanisms to augment watermark resilience in the face of text manipulation attacks. The final watermark code may be defined as Eᵢ=Ê(cᵢ,k), using a watermark code generation function Ê:C×K→ε.

According to certain embodiments, during insertion of the watermark, it may be possible to determine the context code c. The context may represent a string, and based on the string, it may be possible to extract a context code c. The context may refer to the portion of text that the learning model can see at the moment that the learning model predicts the next token. The context may represent the sequence of already-known characters, words, or sub-words that the learning model conditions on when generating the following output. Additionally, the context may supply the semantic, syntactic, and task-specific information that guides the learning model's prediction. The context may also be representative of the cumulative input (the original prompt plus any tokens the learning model has already emitted) that the learning model uses to determine what to output next. The context may further be the immediate textual environment that gives meaning to the upcoming token.

Given an unbiased reweighting function (ε,P_{E},R) and a context code space C, an unbiased watermark code generation function may be a tuple (ε,P_{E},R,C,K,P_{K},Ê) that satisfies unbiasedness [symbol] [R_{Ê(c,k)}(P)]=P,∀P∈Δ_{Σ},∀c∈C, and independence for any n distinct c₁, . . . ,cₙ∈C, where the values R_{Ê(c}_{ᵢ}^{,k)}(P) are mutually independent.

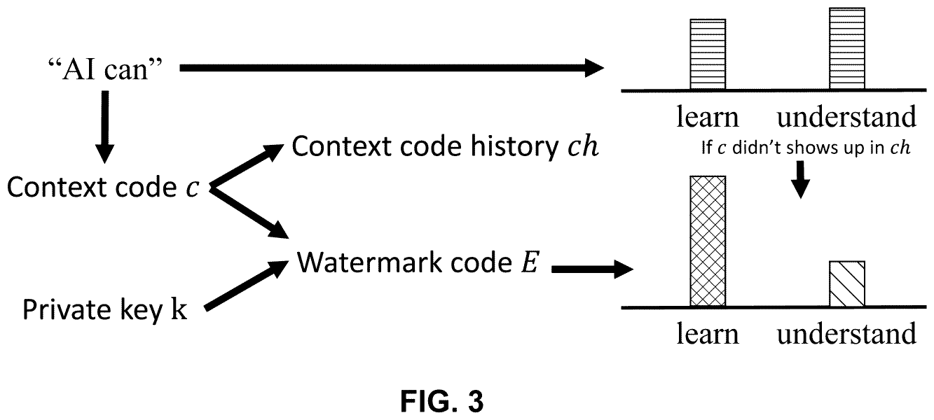

FIG. 3 illustrates an example watermarking flow, according to certain embodiments. As illustrated in FIG. 3, an input “AI can” may be added to a learning model such as, for example, an LLM. Upon receiving the input, the LLM may generate a word such as, for example, “learn” or “understand,” and place the generated word into a string to create the original distribution P. Since the LLM operates in an autoregressive manner, the LLM may repeat the generation of the word/token to create the distribution P (e.g., full sentence).

With the input string “AI can,” it may be possible to extract a context code c which may be used to influence the generation of the next token without modifying the original context itself. On the other hand, when the learning model generates a complete sentence, each newly generated token may be appended to the context. In this sense, the context does not change—as the generation proceeds, the context grows to include all tokens that have already been produced. In certain embodiments, the context extracted from the input may be of any predefined length (e.g., long and short sentences). In some embodiments, a predefined number of recent words may be extracted into a context code c using the latest (e.g., most recent) tokens of the full context (e.g., input string). In certain embodiments, the size of the context code c may be a hyper-parameter may be selected by a system designer, and any integer value may be used. In some embodiments, 1 to 5 tokens may be sufficient for the context code c. Increasing the size of the context code c may strengthen the watermark. However, the increased size may also make the context code c less robust to edits or paraphrasing. In contrast, decreasing the size of the context code c may reduce the watermark's strength, but improve its resilience to modifications.

Furthermore, the context may bind the watermarked token to the surrounding text, and a reweighting performed at each step may depend on the current context resulting in watermark distribution changes. In some embodiments, the context may be needed in the detection of the watermark. For example, detection of the watermark may require the same prior context that was present when the token was generated. Although, small edits to the surrounding text of the context may alter the context codes and therefore the watermark distribution, the watermark may still be recovered in long passages.

As an example of the effect of small context edits, the original watermarked sentence may be: “I like to eat apple for breakfast, savoring the crisp snap and the burst of tart-sweet juice that wakes me up.” Now an edit to a single word is made to obtain: “I like to eat apple for breakfast, because the crisp snap and the burst of tart-sweet juice that wakes me up.” In this example, the words “apple for breakfast” keep the same three-word context and, thus, their watermark code is unchanged. The word “the” that follows the edit now sees a different three-word window where the old context was “breakfast”, “savoring”, and “the”. However, after the edit, it becomes “breakfast”, “because”, and “the”. Consequently, the context codes for “crisp” and “snap” also shift (e.g., their preceding three words change), while words later in the sentence retain the original context code. Thus, from this example, both the private key k and the context can shape the watermarked token distribution, and both may be needed for reliable detection.

After a context conde c is extracted (which may change at each iterative step) a private key k may be introduced with the context code c to generate the watermark code E. The token may be considered watermarked relative to a specific private key k and the exact context at the moment the token was generated. As such, detection of watermarking may use both the context and the private key k; otherwise, a low detection score may result. In some embodiments, the private key k may be unique for each user without any conflict between users. For instance, the private key k may be associated with the identity of the user, which may enable the production of distinct watermark patterns. The private key k may provide secrecy and identity, and using the wrong private key k may typically result in failure of detecting the watermark, and may also lead to different generated outputs.

As illustrated in FIG. 3, the context code c and the private key k may be combined and added to a hash function to determine the watermark code E. The watermark code E may then be used as one parameter in the unbiased reweighting function to detect the watermarking. The output obtained from the watermark code E corresponds to a watermarked distribution Q. That is, the watermarked distribution is created by applying the reweighting operator R to the original distribution P using the watermark code E as a parameter: watermarked distribution=R^{E} (Original Distribution).

In some example embodiments, for any unbiased reweighting function and context code space, an unbiased watermark code generation function always exist. According to some example embodiments, pseudorandom numbers may be used to implement the unbiased watermark code generation function. Specifically, the hash value hash(c,k) may be used as a random seed to sample E from P_{E} as an implementation of E=Ê(c,k). In certain embodiments, an unbiased watermark code generation function may ensure that the watermark codes Eᵢ are independent with each other if only their context codes are different. During the generation of a sequence, context codes may be repeated. If cᵢ and cᵢ are equal, then Eᵢ and Eⱼ are also equal, violating the independence of Eᵢ. It may be possible to skip reweighting for a token when encountering a previously used context code by, for example, setting P_{M,w}(·|a_{1:m},x_{1:i-1})=P_{M}(·|a_{1:m},x_{1:i-1}) if the context code has previously appeared.

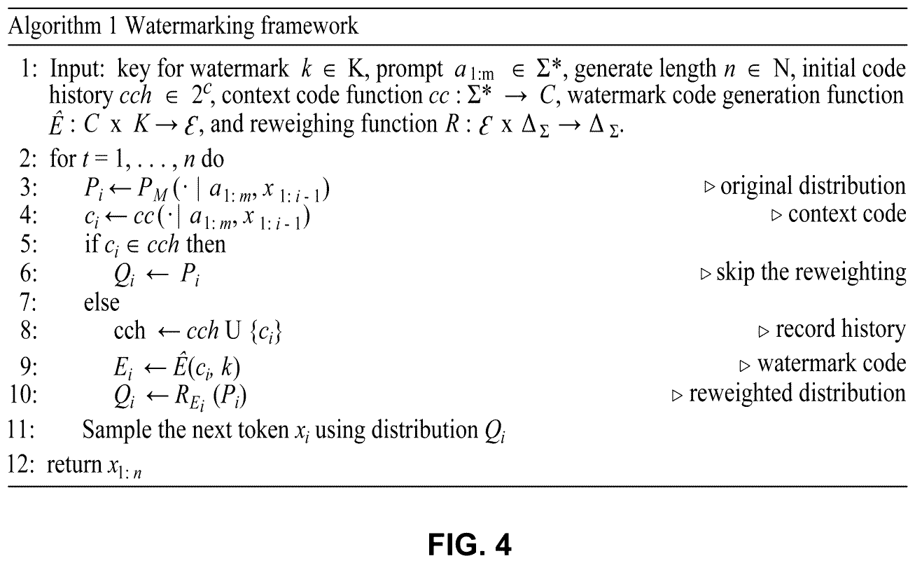

FIG. 4 illustrates an example framework for watermarking, according to certain embodiments. As illustrated in FIG. 3, the framework may include two components to be implemented: the unbiased reweight function R_{E} and the context code function c.

According to certain embodiments, it may be possible to detect watermarking. As described herein, there is a process of adding a watermark to a text based on a secret key k and a given prompt a_{1:m}. The watermark-embedded text may be sampled from the distribution P_{M,w}(x_{1:n}|a_{1:m};k). This problem may be formulated as a statistical hypothesis test between two competing hypotheses: H₀, which posits that x_{1:n} follows the unmarked distribution, and H₁, which posits that x_{1:n} follows the marked distribution.

In certain example embodiments, a score-based testing may be provided, which assigns a score to each token in the text. The score may be interpreted as the confidence that the token was generated by the watermark model rather than the original model. Scores sᵢ may be determined based on x_{1:i}, in accordance with the autoregressive manner of the generation process.

The total score S may be given by

$$S = {\sum }_{i = 1}^{n} {s}_{i} .$$

A threshold Ŝ may be set such that if S<Ŝ, the null hypothesis H₀ is accepted, indicating insufficient evidence to conclude that the text contains a watermark. Otherwise, the null hypothesis is rejected. In certain embodiments, there may be two types of error probabilities associated with the decision process including, for example, a type I error and a type II error. In a type I error, the probability of incorrectly rejecting the null hypothesis is under H₀, denoted as P_{H}_{₀}(S≥Ŝ). In a type II error, the probability of incorrectly accepting the null hypothesis is under H₁, denoted as P_{H}_{₁}(S<Ŝ).

Theoretical results may be derived by utilizing specific properties of the scores. For example, under the null hypothesis H₀, the exponential momentum of sᵢ is bounded, conditioned on the preceding context x_{1,i-1}. This requirement leads to an upper bound on α, the type I error probability.

According to certain embodiments, detection of watermarking may also be performed by rerunning the watermarking workflow to obtain multiple distributions (where each position only computes one distribution), and checking how each distribution changes for each token. For instance, for a particular token, the probability of the old/original token may be increased to the new probability. This may be seen in FIG. 3 where the probability for the word “learn” is increased from the original distribution P to watermarked distribution Q, and the probability for the word “understand” is decreased from the original distribution P to the watermarked distribution Q. As such, during detection of the word “understand,” it is unlikely that there is watermarking because if there was watermarking, the word “learn” would be more likely to be observed. From the word “learn,” it is apparent that the probability increased after adding the watermark from the original distribution P to the watermarked distribution Q. As such, the word “learn” may be assigned a positive score indicating that watermarking is present. According to certain embodiments, if the input string is long with many tokens/words, a score may be determined for each token/word, after which all the scores may be aggregated. In some embodiments, there may be provided a statistically significant hypothesis test based on a threshold where the threshold S is defined as “S=log a.” The decision rule may be: no watermark if \ (S<\hat S\); watermark present if \ (S \ge \hat S\). Simply counting positive versus negative occurrences may discard the magnitude of the scores and, thus, is not equivalent to this test and does not provide an upper bound on the error rate.

To derive theoretical results, the scores may also have a particular property where the exponential momentum of sᵢ under H₀ should be bounded, conditioned on the previous text x_{1,i-1}. This requirement leads to an upper bound on the type I error rate.

Given a probability space (Ω, [symbol] ,P) and a Σ-valued stochastic process xᵢ:1≤i≤n, as well as an [symbol] -valued stochastic process sᵢ:

$$1 \leq i \leq n , let {ℱ}_{i}^{x} := σ ( {x}_{j} \vert 1 \leq j \leq i ) and {ℱ}_{i}^{s} := σ ( {s}_{j} \vert 1 \leq j \leq i )$$

be the corresponding filtrations, where σ(·) denotes the σ-algebra generated by random variables. If

$${ℱ}_{i}^{s} ⊆ {ℱ}_{i}^{x} and 𝔼 [ exp ( {s}_{i} ) \vert {ℱ}_{i - 1}^{x} ] \leq 1 , then P ( {\sum }_{i = 1}^{n} {s}_{i} \geq t ) \leq {e}^{- t} .$$

Thus, to ensure that the type I error probability has an upper bound a, the threshold S may be set as Ŝ=−log (α).

According to certain embodiments, an LLR test of the distribution may be performed. A LLR score is defined as

$${s}_{i} = log \frac{{P}_{M , w} ( {x}_{i} \vert {a}_{1 : m} {x}_{1 : i - 1} ; k )}{{P}_{M} ( {x}_{i} \vert {a}_{1 : m} , {x}_{1 : i - 1} )} ,$$

and the total score becomes

$$S = log \frac{{P}_{M , w} ( {x}_{1 : n} \vert {a}_{1 : m} ; k )}{{P}_{M} ( {x}_{1 : n} \vert {a}_{1 : m} )} .$$

An optimization derivation of the above sᵢ may be provided to gain intuition and set the foundation for the maximum variant of the LLR score. For instance, it may be possible to set Pᵢ=P_{M}(·|a_{1:m},x_{1:i-1}), Qᵢ=P_{M,w}(·|a_{1:m},x_{1:i-1}; k), and let sᵢ=Sᵢ(xᵢ)∈ [symbol] denote the score corresponding to different xᵢ. In this example, Pᵢ, Qᵢ, and Sᵢ are all functions with a signature of Σ→ [symbol] , thus equivalent to vectors of dimension |Σ|. The inner product may be defined as [symbol] Pᵢ,Sᵢ [symbol] =Σ_{x∈Σ}Pᵢ(x)Sᵢ(x).

The requirement

$$𝔼 [ exp ( {s}_{i} ) \vert {ℱ}_{i - 1}^{x} ] \leq 1$$

may be reformulated as [symbol] Pᵢ,exp(Sᵢ) [symbol] ≤1, where the exponential function is applied element-wise. Instead of minimizing the type II error directly, certain embodiments aim to maximize the average score under H₁ (e.g., [symbol] Qᵢ,Sᵢ [symbol] ). The optimization problem becomes max_{S}_{ᵢ} [symbol] Qᵢ,Sᵢ [symbol] , s.t. [symbol] Pᵢ,exp(Sᵢ) [symbol] ≤1. The optional solution is given by

$${S}_{i} ( x ) = log \frac{{Q}_{i} ( x )}{{P}_{i} ( x )} ,$$

which recovers the optimal log likelihood ratio score.

According to certain embodiments, the LLR test may be implemented to distinguish between the original distribution P and the watermarked distribution Q. the LLR test may achieve the optimal trade-off between type I (false positive) and type II (false negative) errors. The LLR test compares the likelihood of a given text under P and Q, and if the ratio exceeds a threshold, the text is classified as watermarked. To ensure an upper bound for type I error, the threshold Ŝ=−log (α).

In certain embodiments, a maximin variant of the LLR score may be provided. A limitation of the LLR score described above is that when Qᵢ(x)=0, Sᵢ(x)=−∞. This means that as long as a single token does not come from the watermark model P_{M,w}, the score becomes negative infinity, making it impossible to reject the null hypothesis H₀.

Another reason for the drawback of the LLR score is that the watermark model P_{M,w} used in the detection process may not exactly match the true distribution of the watermarked text. For instance, potential sources of discrepancy may include editing (e.g., a text sampled from P_{M,w} may undergo some degree of editing before watermark detection) and imperfect estimation of the generation process (e.g., due to lack of knowledge of the exact prompt and temperature used during generation).

To address the issues with the LLR score, certain embodiments may consider a perturbed generation distribution. For example, instead of the original hypothesis H₁, where x_{1:n} follows the watermark distribution P_{M,w}, it may be assumed that x_{1:n} follows a distribution P′_{M,w}, which is similar to but not identical to P_{M,w}. Specifically, during the generation of each token, the total variation (TV) distance between Q′ᵢ and Qᵢ is bounded by d.

According to certain embodiments, the TV measures the overall discrepancy between two discrete probability distributions P and [symbol] . In one example, a TV of 0 means the distributions are identical, and a TV of 2 is the maximum possible difference. [symbol] represents the watermarked next-token distribution at step i, obtained by applying the unbiased reweighting to the model's original prediction. [symbol] ′ᵢ represents a perturbed version of Qᵢ used at detection time to model edits/post-processing, and Q′ᵢ may differ from Qᵢ. The bounded variable d represents a hyper-parameter that controls how much perturbation is allowed when forming Q′ᵢ. For example, larger values of d correspond to assuming that more editing or noise has occurred between the generation of the watermarked text and the detection step.

In certain embodiments, TV may provide a simple uncertainty set (a TV ball) around Qᵢ to model the worst-case edits between generation and detection. The TV may provide a linear form that makes the maximum variant of the LLR detection problem easy to solve.

Based on the above, a corresponding new optimization problem may be provided as follows:

$${max}_{{S}_{i}} {min}_{{Q}_{i}^{′} ∈ {Δ}_{Σ} , TV ( {Q}_{i}^{′} , {Q}_{i} ) \leq d} 〈 {Q}_{i}^{′} , {S}_{i} 〉 , s . t . 〈 {P}_{i} , exp ( {S}_{i} ) 〉 \leq 1.$$

Intuitively, the optimal solution for Q′i in the inner optimization decreases Q′ᵢ(x) when Sᵢ(x) is large, and increases Q′ᵢ(x) when Sᵢ(x) is small.

The computation of the maximin solution may be performed efficiently in Õ(|Σ|) time. Additionally, the maximum variant of the LLR score may be more robust than the standard LLR score, as it yields higher scores when the text has undergone some degree of editing.

According to certain embodiments, a hyperparameter d∈[0,1] represents the perturbation strength, and is introduced in the LLR score. If the text to be detected has undergone more editing and deviates further from the distribution P_{M,w}, d should be larger. In some embodiments, it may be recommended to use a grid search to select the best value of d. Assuming there are A candidate values for d, corresponding to A difference scores

$${s}_{i}^{( a )} ( 1 \leq a \leq A ) ,$$

it may be possible to modify the following equation with multiple scores

$${s}_{i}^{( a )}$$

to obtain

$$P ( {max}_{1 \leq a \leq A} ( {\sum }_{i = 1}^{n} {s}_{i}^{( a )} ) \geq t ) \leq {Ae}^{- t} .$$

Thus, when using grid search, the final threshold may be adjusted as Ŝ=−log (α)+log (A).

According to the above embodiments, it may be possible to account for the sensitivity of the LLR test to perturbations in both P and Q. For instance, if the text is modified before watermark detection, the true watermarked distribution may differ from the assumed Q. To address this issue, a robust LLR test may be implemented to introduce a distribution-robust optimization term. This term allows for a small perturbation in Q, making the test more resilient to text modifications while still maintaining its detection power.

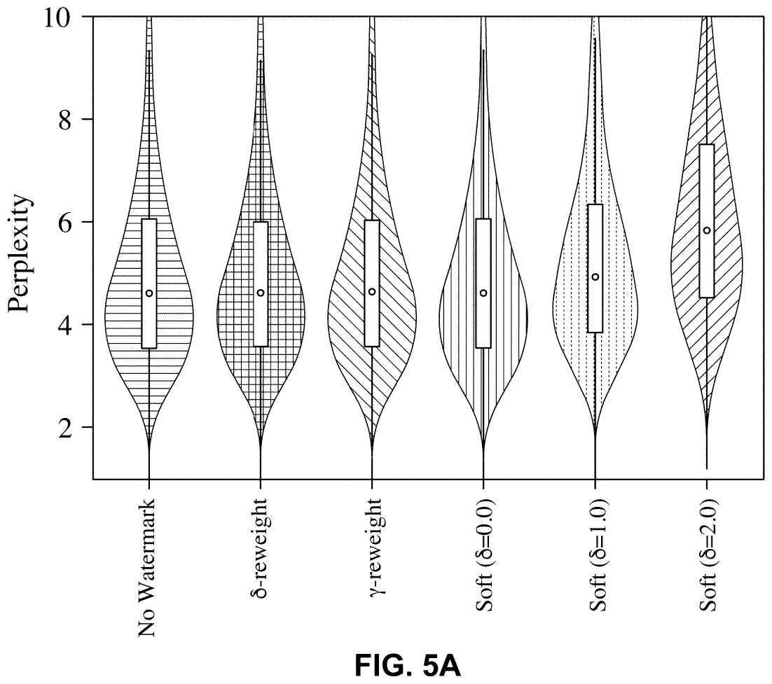

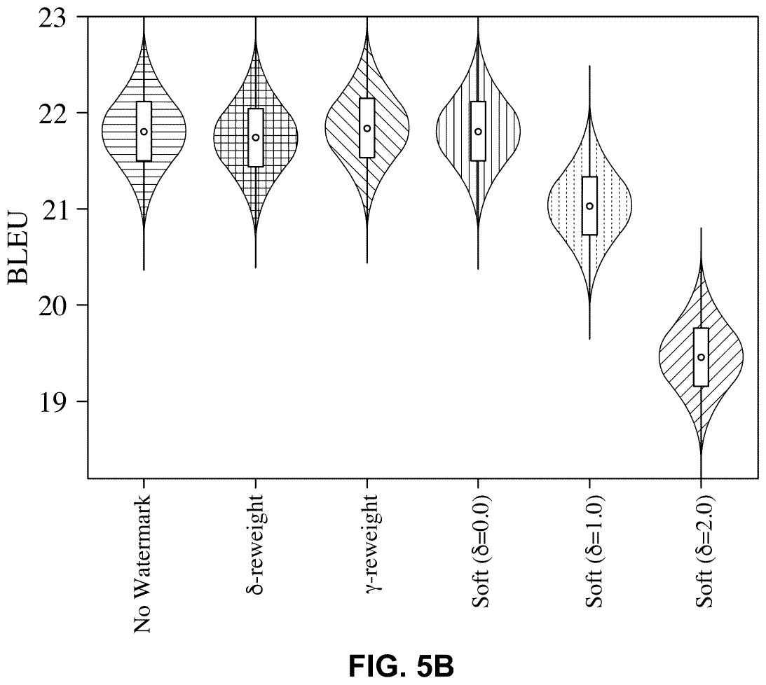

FIG. 5A illustrates an example distribution of perplexity of outputs for text summarization (TS) and bilingual evaluation understudy (BLEU) score for machine translation (MT), according to certain embodiments. Further, FIG. 5B illustrates an example of another distribution of perplexity of outputs for TS and BLEU score for machine translation (MT), according to certain embodiments. FIGS. 5A and 5B demonstrate that the unbiased watermarking method preserves output quality. For example, there is no observable difference in either the mean (average) or distribution of output quality compared to non-watermarked outputs. In contrast, other biased watermarking methods show a clear quality degradation. This empirically verifies that the unbiased method is truly unbiased, as it maintains the original model's performance without compromising quality.

In certain embodiments, the performance of unbiased watermarks may be evaluated on two applications of seq2seq models: text summarizations (TS) and machine translation (MT). For the TS task, the BART-large model was used and the CNN-DM corpus was used as the testing dataset. The MT task involves translating English to Romanian, for which the Multilingual BART (MBart) model was employed on the WMT′ 14 En-Ro corpus.

According to certain embodiments, it may be possible to determine whether the watermarking procedure is biased or unbiased. For instance, to resolve any bias issue in the output of the learning model, a single watermarked distribution [symbol] may be used. In one example, the bias in the output of the learning model may be resolved while maintaining quality, by employing unbiased reweighting whereby a family of watermarked distributions [symbol] parameterized by a random watermark code E is used such that Σ[ [symbol] ]=P. In another example, multiple watermarked distributions may be used including, for example, [symbol] and [symbol] , whose combination recovers the original distribution P. The choice between [symbol] and [symbol] may depend on a secret key k. For an observer without the secret key k, the expected output distribution from the watermarked model is identical to the original model, ensuring unbiasedness. However, for someone with the secret key k, the likelihood ratio between the corresponding [symbol] and P could be large, allowing for reliable watermark detection. This approach may effectively resolve the dilemma between watermark strength and watermark bias.

In certain embodiments, an approach to resolve biasedness may include utilizing two components: an unbiased reweight; and using each watermark only once. In the first component, use of the unbiased reweight may take the form of: Q=R_{E}(P) [symbol] [R_{E}(P)]=P. Here, the unbiased reweighting may ensure that the expected watermarked distribution matches the original distribution. In the first component, a determination may be made as to whether generation of a single token is unbiased by checking the distribution without a watermark and the distribution after watermarking to obtain two distributions. The watermarked distribution may depend on the private key k. If the expectation of watermarked distribution with regard to the private key k recovers the original distribution, it satisfies the math equation and is unbiased.

According to certain embodiments, if the identity of the user/private key k is changed, a different distribution may be obtained. If there are an excess number of watermark keys and distributions, the average of the distributions may be obtained, and the average may cover the original distribution, which is classified as “unbiased.”

As to the second component, each watermark code may only be used once in the generation process to ensure that the distribution of tokens for an entire sentence is unbiased. To accomplish this unbiasedness, the system is restricted from using the same watermark code more than once. If the same watermark code appears again, it is skipped and the watermark is not added. Since the watermark is abstract representing information from the context code and private key, the only changing part is the context code. As such, only the context code may need to be checked if it is a duplicate of a previous context code by referencing the recorded context code history.

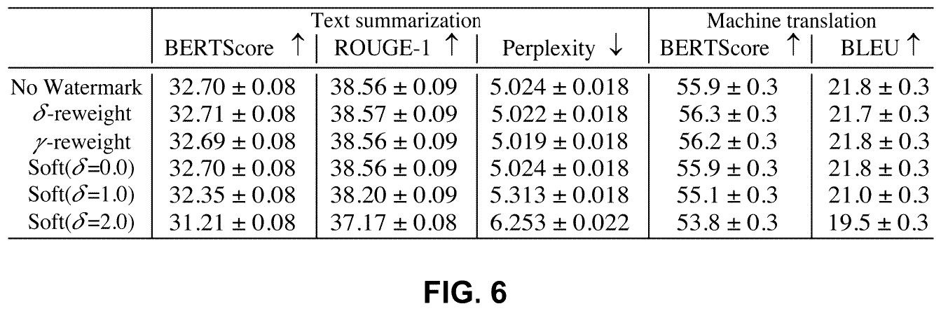

FIG. 6 illustrates a table of performance results of different watermarking methods, according to certain embodiments. Specifically, the table of FIG. 6 includes performance results of different watermarking methods on TS and MT where F1 scores of BERTScore and scale BERTScore and ROUGE-1 scores are used with a factor of 100. As shown in FIG. 5, a comparison is made between the performance of the unbiased watermarking methods which include the δ-reweight and the γ-reweight, with the soft-red-list method. The watermark strength in the soft-red-list approach is controlled by a parameter δ.

As shown in FIG. 6, from the quality of the output post-watermarking, it may be observed that the output quality remains unaffected by the unbiased watermark methods, both for the δ-reweight and the γ-reweight, irrespective of the task and metric. Conversely, the soft-red-list method, when δ=0, does not introduce any watermark and there fore does not affect the output quality. However, for δ>0, it may significantly impair the quality of the output.

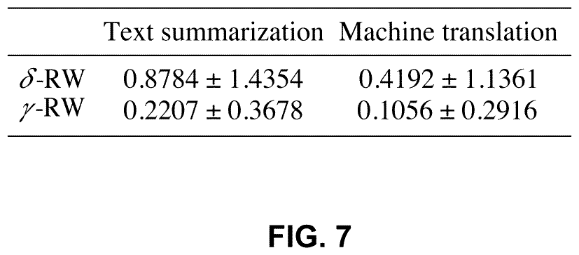

In terms of watermark detection, the score associated with each token may be determined. The mean and variance of the score per token for TS and MT are presented in FIG. 7, which illustrates the mean and variance score per token for different reweighting methods and different tasks, according to certain embodiments. As a heuristic, if the sum of the scores for all tokens in a sentence reaches 10, a p-value of less than 0.0005 may be ensured. If the sum score reaches 20, the p-value must be less than 3e-8.

According to certain embodiments, the unbiased watermark may also be detected in a likelihood-agnostic way such that it does not rely on a language model and its output logits to compute the score. For instance, in some embodiments, the same δ-reweighting described above may be used with a different implementation. Instead of using inverse sampling, the Gumbel trick may be applied. Specifically, each watermark code may be a list of |Σ| number of independent and identically distributed standard Gumbel variables. The watermark code space is ε= [symbol] . The probability density function of the watermark code is given by

$${P}_{E} ( E ) = {\prod }_{a ∈ Σ} {e}^{- E ( a ) + {e}^{E ( a )}} .$$

To sample a token using the Gumbel trick, α*=argmax_{α}{log P(α)+E(α)} is computed, and the reweighted distribution becomes Q=δ_{α*}. The Gumbel variables provide the ability to guess the likelihood of a token coming from the watermark model without relying on logits, as tokens with larger Gumbel variables are more likely to be picked by the watermark model.

In certain embodiments, scores for each token may be calculated without relying on the original and reweighted distribution P and Q. Thus, the design of the likelihood-agnostic score may have a certain degree of arbitrariness. In certain embodiments, the score may be selected to be sᵢ=ln2−exp (−E(α*)). One concern of this construction is that it may yield a tail bound. For n independent random variables Gᵢ˜ Gumbel(0,1), if sᵢ=ln2−exp (−Gᵢ) is defined, the following may be achieved: [symbol] [exp(sᵢ)]≤1 and

$$P ( {\sum }_{i = 1}^{n} {s}_{i} \leq t ) \leq {e}^{- t} .$$

For a token with watermark, the average score is [symbol] [ln2−exp (−Gᵢ(α*))]=ln2−Σ_{α∈Σ}P(α)²=ln2−exp(−H₂(P)), where H₂(P) is the Rényi entropy of order 2. Thus, the average score may be positive only when the entropy is high.

According to certain embodiments, the n independent random variables may require independence of sᵢ. The Gumbel variables may depend on the watermark code, and the watermark code may repeat, leading to dependencies between Gumbel variables and, thus, between scores. To address this issue, for repeating context codes, the score may be set to zero, ensuring that the n independent random variables remain appliable.

In certain embodiments, the detection process may be as follow, given a text x_{1:n}=(x₁, . . . ,xₙ), it may be possible to obtain a series of context codes (cc₁, . . . ,ccₙ) and watermark codes (E₁, . . . ,Eₙ). The final scores may be determined as:

$${s}_{i} = \{ \begin{matrix}ln 2 - exp ( - {E}_{i} ( {x}_{i} ) ) & if {cc}_{i} ∉ {cc}_{1} , … , {cc}_{i - 1} , \\ 0 & if {cc}_{i} ∈ {cc}_{1} , … , {cc}_{i - 1} .\end{matrix}$$

From the above examples, it can be seen that the likelihood-agnostic approach may assume that there is no knowledge of the language model probability of the original distribution. For instance, in the example sentence “I like to eat apple for breakfast”, under the likelihood-agnostic approach, there is no knowledge of the language model probability that “apple” follows the prefix “I like to eat”. Instead of consulting the model's conditional probabilities, the detection relies on the token itself, and the watermark code derived from the token and the surrounding context.

According to certain embodiments, a new score may be determined from the token and the watermark code. Because the new score does not incorporate ethe true token likelihood, the score may be viewed as a “weak” or noisier approximation of the likelihood-based score. Consequently, the new score may be lower and more tolerant of uncertainty.

Similar to the likelihood-based detection described herein, the likelihood-agnostic approach may include recomputing the codes. In this re-computation, for each position in the candidate text, the context code is recomputed from the observed preceding tokens and then combined with the private key to obtain the watermark code for that position.

Once the re-computation is completed, a simple match signal sᵢ may be determined using the observed token at/and the watermark code at i. The match signal sᵢ measures how well the token aligns with the keyed code.

To obtain the score S, an aggregation is performed by taking the sum or average of the signals over positions. The score S may be compared to a precomputed null distribution (e.g., what S would look like without a watermark) to obtain a p-value or threshold decision. With the score S, it may be possible to perform a decision where if S exceeds the threshold, the text is declared watermarked; otherwise, watermarking is not detected. Thus, by implementing the likelihood-agnostic detection, the explicit language model likelihood is discarded, and the decision is based solely on the token-plus-watermark information, trading accuracy for reduced computational cost.

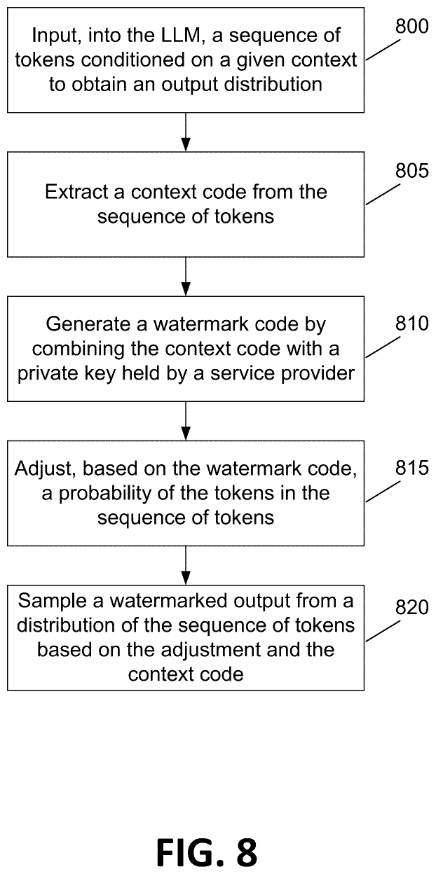

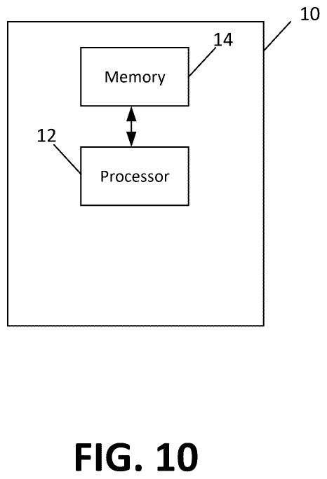

FIG. 8 illustrates an example flow diagram of a method, according to certain example embodiments. In an example embodiment, the method of FIG. 8 may be performed by a system that includes a computer apparatus, computer system, network, neural network, apparatus, or other similar device(s). According to certain embodiments, each of these apparatuses of the system may be represented by, for example, an apparatus similar to apparatus 10 illustrated in FIG. 10.

As illustrated in FIG. 8, the method may include, at 800, inputting, into the LLM, a sequence of tokens conditioned on a given context to obtain an output distribution. The method may also include, at 805, extracting a context code from the sequence of tokens. The method may further include, at 810, generating a watermark code by combining the context code with a private key which is unique to a user. In addition, the method may include, at 815, adjusting, based on the watermark code, a probability of the tokens in the sequence of tokens. Further, the method may include, at 820, sampling a watermarked output from a distribution of the sequence of tokens based on the adjustment and the context code.

According to certain embodiments, the watermarked output/distribution may be used for anything that a user may use LLM answers for. In certain embodiments, the watermarked output may be detected if the user inserting the watermark wants the watermarked output to be detected. For example, a user may ask the LLM to summarize papers or concepts in items that need to be assessed. For the summaries that the user generates, the user may insert a watermark to differentiate one summary from other summaries. Further, in academics, the user may use the watermarked output may be used to prevent plagiarism of work products, and academic institutions (e.g., universities and/or other schools) may have a proprietary model that watermarks its output so faculty may know whether or not students wrote their own work.

In other embodiments, the watermarked output may be implemented in tracking counterfeit currency. For instance, law enforcement entities may mark specific bills so that the bills may be detected and traced later. However, the bills are still legal currency and can be used to purchase anything that the person who has it wants. Similarly, a watermark in an LLM output may be used to detect/trace that output, but the output itself may be used for what the user asks the LLM for in the first place (e.g., writing summaries, bedtime stores for ids, recipes, etc.). As such, in certain embodiments, use cases for the watermarked output may differ depending on what the user who made the LLM query wants to use it for.

According to certain embodiments, the method may further include recording a context code history comprising a plurality of context codes extracted from a plurality of iterations of the LLM. According to some embodiments, the context code may be utilized a single time. According to some embodiments, each context code in the history may be used at most once for reweighting, upon determining that a context code has previously occurred in the history. According to other embodiments, reweighting may be bypassed for the corresponding token.

In certain embodiments, the adjustment may include implementing a reweight function on the tokens in the sequence of tokens. In some embodiments, the reweight function may include a delta reweight function, and a gamma reweight function. In some embodiments, the delta reweight function may include assigning each individual watermark that is uniformly sampled from an interval [0, 1] corresponding to a token of the sequence of tokens such that the token has a probability of 1, and all other tokens of the sequence of tokens have a probability of 0.

According to certain embodiments, the gamma reweight function may include randomly permuting a vocabulary set defined in the sequence of tokens. The gamma reweight function may also include determining, in a permuted order, a cumulative probability of an original next-token distribution and setting to zero the probabilities of tokens of the sequence of tokens whose cumulative probability is less than or equal to ½. The gamma reweight function may further include scaling the probabilities of remaining tokens of the sequence of tokens by a factor of 2. The gamma reweight function may also include normalizing the scaled probabilities of the remaining tokens to form a reweighted distribution. According to other embodiments, the watermarked output of a distribution of the sequence of tokens may be conditioned on the private key from a key space and a context.

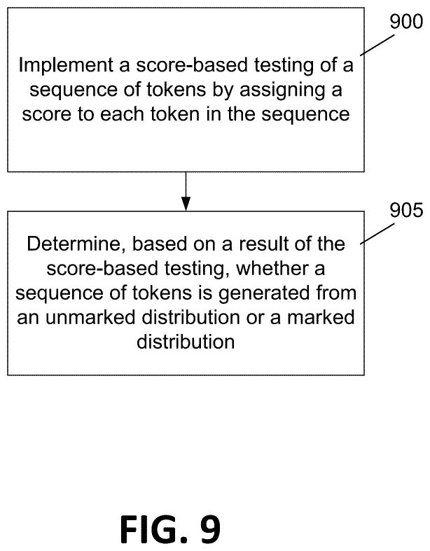

FIG. 9 illustrates an example flow diagram of another method, according to certain example embodiments. In an example embodiment, the method of FIG. 9 may be performed by a system that includes a computer apparatus, computer system, network, neural network, apparatus, or other similar device(s). According to certain embodiments, each of these apparatuses of the system may be represented by, for example, an apparatus, similar to apparatus 10 illustrated in FIG. 10.

As illustrated in FIG. 9, the method may include, at 900, implementing a score-based testing of a sequence of tokens by assigning a score to each token in the sequence. The method may also include, at 905, determining, based on a result of the score-based testing, whether a sequence of tokens is generated from an unmarked distribution or a marked distribution. According to certain embodiments, the score indicates a confidence that the tokens in the sequence were generated by a watermark model rather than an un-watermarked model.

According to certain embodiments, the score is determined based on a context in accordance with an autoregressive manner of the generation process. According to some embodiments, the method may also include determining whether a total score of the sequence of tokens differs by more than a predetermined threshold score. According to other embodiments, when the total score of the sequence of tokens is greater than the predetermined score, the method may also include determining that the sequence of tokens contains a watermark.

In certain embodiments, when the total score of the sequence of tokens is less than the predetermined score, the method may also include determining that the sequence of tokens does not contain a watermark. In some embodiments, the method may further include setting and searching for a hyper-parameter of a log-likelihood ratio, determining a maximum log-likelihood ratio based on the hyper-parameter, and adjusting a detection threshold based on a grid search process. In other embodiments, the method may also include comparing the adjusted detection threshold with the maximum log-likelihood ratio. In other embodiments, the score may be determined via a likelihood-agnostic watermark test based on the sequence of tokens.

Certain embodiments may provide a method of unbiased watermarking a LLM that generates a non-watermarked output in response to a prompt defined by a first probability distribution and a first quality score. The method may include introducing a watermark code into the large language model. The method may also include generating a watermarked output in response to the prompt, the watermarked output including a watermark defined by the watermark code and defining a second probability distribution with an expectation of being identical to the first probability distribution, and a second quality score identical to the first quality score such that the watermark is undetectable without the watermark code.

Although only one apparatus is illustrated in FIG. 10, the apparatus may represent multiple apparatus as part of a system or network. For example, in certain embodiments, apparatus 10 may be a computer apparatus that operate individually or together as a system.

In some embodiments, the functionality of any of the methods, processes, algorithms or flow charts described herein may be implemented by software and/or computer program code or portions of code stored in memory or other computer readable or tangible media, and executed by a processor.

For example, in some embodiments, apparatus 10 may include one or more processors, one or more computer-readable storage medium (for example, memory, storage, or the like), one or more radio access components (for example, a modem, a transceiver, or the like), and/or a user interface. It should be noted that one of ordinary skill in the art would understand that apparatus 10 may include components or features not shown in FIG. 10, and other embodiments may include multiple apparatuses similar to apparatus 10 that are interconnected via a network or are connected to each other either wireless and/or wired connections.

As illustrated in the example of FIG. 10, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 10, multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-9.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-9.

Additionally or alternatively, in some embodiments, apparatus 10 may include an input and/or output device (I/O device). In certain embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, processor 12 and memory 14 may be included in or may form a part of processing circuitry or control circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware.

For instance, in certain example embodiments, apparatus 10 may be controlled by memory 14 and processor 12 to input, into the LLM, a sequence of tokens conditioned on a given context to obtain an output distribution. Apparatus 10 may also be controlled by memory 14 and processor 12 to extract a context code from the sequence of tokens. Apparatus 10 may further be controlled by memory 14 and processor 12 to generate a watermark code by combining the context code with a private key which is unique to a user. In addition, apparatus 10 may be controlled by memory 14 and processor 12 to adjust, based on the watermark code, a probability of the tokens in the sequence of token. Further, apparatus 10 may be controlled by memory 14 and processor 12 to sample a watermarked output from a distribution of the sequence of tokens based on the adjustment and the context code.

In other example embodiments, apparatus 10 may be controlled by memory 14 and processor 12 to determine whether a sequence of tokens is generated from an unmarked distribution or a marked distribution. Apparatus 10 may further be controlled by memory 14 and processor 12 to implement, based on the determination, a score-based testing of the sequence of tokens by assigning a score to each token in the sequence. According to certain embodiments, the score indicates a confidence that the tokens in the sequence were generated by a watermark model rather than an un-watermarked model.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for inputting, into the LLM, a sequence of tokens conditioned on a given context to obtain an output distribution. The apparatus may also include means for extracting a context code from the sequence of tokens. The apparatus may further include means for generating a watermark code by combining the context code with a private key which is unique to a user. In addition, the apparatus may include means for adjusting, based on the watermark code, a probability of the tokens in the sequence of tokens. Further, the apparatus may include means for sampling a watermarked output from a distribution of the sequence of tokens based on the adjustment and the context code.

Other example embodiments may be directed to an apparatus that includes means for determining whether a sequence of tokens is generated from an unmarked distribution or a marked distribution. The apparatus may also include means for implementing, based on the determination, a score-based testing of the sequence of tokens by assigning a score to each token in the sequence. According to certain embodiments, the score indicates a confidence that the tokens in the sequence were generated by a watermark model rather than an un-watermarked model.

Certain example embodiments described herein provide several technical improvements, enhancements, and/or advantages. For instance, in some example embodiments, it may be possible to provide a more intuitive depiction of the score distribution, and provide unbiased watermark methods that not only ensure that the mean performance remains unaffected, but also that the performance distribution is stable. Conversely, the soft-red-list method shows a notable performance decrease. In certain embodiments, it may also be possible to provide an example of watermarking applied to a completion task. For instance, certain embodiments may provide a visual demonstration of the score distribution across tokens where positive and negative scores are represented. The intensity of a color of the scores may correspond to the magnitude of the score, with darker shades representing larger absolute values.

According to other embodiments, it is possible to provide a framework of watermarking for language models, demonstrating that it is possible to use watermark to protect intellectual property and monitor potential misuse without compromising the quality of the generated text.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical 1 carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware or circuitry included in an apparatus (e.g., apparatus 10), for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an example embodiment, an apparatus, such as a device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

Partial Glossary:

| | |
|---|---|
| AI | Artificial Intelligence |
| API | Application Programming Interface |
| LLM | Large Language Model |
| LM | Language Model |
| MT | Machine Translation |
| TS | Text Summarization |

We claim:

1. A method of watermarking a large language model (LLM), comprising:
inputting, into the LLM, a sequence of tokens conditioned on a given context to obtain an output distribution;
extracting a context code from the sequence of tokens;
generating a watermark code by combining the context code with a private key held by a service provider;
adjusting, based on the watermark code, a probability of the tokens in the sequence of tokens; and
sampling a watermarked output from a distribution of the sequence of tokens based on the adjustment and the context code.

2. The method according to claim 1, further comprising:
recording a context code history comprising a plurality of context codes extracted from a plurality of iterations of the LLM,
wherein the context code is utilized a single time.

3. The method of claim 1, wherein the adjustment comprises implementing a reweight function on the tokens in the sequence of tokens.

4. The method according to claim 1, wherein the reweight function comprises:
a delta reweight function; and
a gamma reweight function.

5. The method of claim 4, wherein the delta reweight function comprises assigning each individual watermark that is uniformly sampled from an interval [0, 1] corresponding to a token of the sequence of tokens such that the token has a probability of 1, and all other tokens of the sequence of tokens have a probability of 0.

6. The method according to claim 4, wherein the gamma reweight function comprises:
randomly permuting a vocabulary set defined in the sequence of tokens;
determining, in a permuted order, a cumulative probability of an original next-token distribution and setting to zero the probabilities of tokens of the sequence of tokens whose cumulative probability is less than or equal to ½;
scaling the probabilities of remaining tokens of the sequence of tokens by a factor of 2; and
normalizing the scaled probabilities of the remaining tokens to form a reweighted distribution.

7. The method according to claim 1, wherein the watermarked output of a distribution of the sequence of tokens is conditioned on the private key from a key space and a context.

8. A method of detecting watermarking in an output of a large language model (LLM), comprising:
implementing a score-based testing of a sequence of tokens by assigning a score to each token in the sequence; and
determining, based on a result of the score-based testing, whether a sequence of tokens is generated from an unmarked distribution or a marked distribution,
wherein the score indicates a confidence that the tokens in the sequence were generated by a watermark model rather than an un-watermarked model.

9. The method according to claim 8, wherein the score is determined based on a context in accordance with an autoregressive manner of the generation process.

10. The method according to claim 8, further comprising:
determining whether a total score of the sequence of tokens differs by more than a predetermined threshold score.

11. The method according to claim 10, wherein when the total score of the sequence of tokens is greater than the predetermined score, the method comprises:
determining that the sequence of tokens contains a watermark.

12. The method according to claim 10, wherein when the total score of the sequence of tokens is less than the predetermined score, the method comprises:
determining that the sequence of tokens does not contain a watermark.

13. The method according to claim 8, further comprising:
setting and searching for a hyper-parameter of a log-likelihood ratio;
determining a maximum log-likelihood ratio based on the hyper-parameter;
adjusting a detection threshold based on a grid search process; and
comparing the adjusted detection threshold with the maximum log-likelihood ratio.

14. The method according to claim 8,
wherein the score is determined via a likelihood-agnostic watermark test based on the sequence of tokens.

15. An apparatus for watermarking a large language model (LLM), comprising:
at least one processor; and
at least one memory including computer program code which, when executed by the at least one processor, cause the apparatus to at least:
input, into the LLM, a sequence of tokens conditioned on a given context to obtain an output distribution;
extract a context code from the sequence of tokens;
generate a watermark code by combining the context code with a private key held by a service provider;
adjust, based on the watermark code, a probability of the tokens in the sequence of tokens; and
sample a watermarked output from a distribution of the sequence of tokens based on the adjustment and the context code.

16. The apparatus according to claim 15, wherein the at least one memory storing the instructions, when executed by the at least one processor, further cause the apparatus at least to:
record a context code history comprising a plurality of context codes extracted from a plurality of iterations of the LLM,
wherein the context code is utilized a single time.

17. The apparatus of claim 15, wherein the adjustment comprises implementing a reweight function on the tokens in the sequence of tokens.

18. The apparatus according to claim 15, wherein the reweight function comprises:
a delta reweight function; and
a gamma reweight function.

19. The apparatus of claim 18, wherein the delta reweight function comprises assigning each individual watermark that is uniformly sampled from an interval [0, 1] corresponding to a token of the sequence of tokens such that the token has a probability of 1, and all other tokens of the sequence of tokens have a probability of 0.

20. The apparatus according to claim 18, wherein the gamma reweight function comprises:
randomly permuting a vocabulary set defined in the sequence of tokens;
determining, in a permuted order, a cumulative probability of an original next-token distribution and setting to zero the probabilities of tokens of the sequence of tokens whose cumulative probability is less than or equal to ½;
scaling the probabilities of remaining tokens of the sequence of tokens by a factor of 2; and
normalizing the scaled probabilities of the remaining tokens to form a reweighted distribution.
